(19) United States
(12) Patent Application Publication
(10) Pub. No.: US 2025/0389481 A1
(43) Pub. Date: Dec. 25, 2025

(54) VIBRATING MESH ATOMIZER FOR DRY POWDER GENERATION AND METHOD OF MAKING THE SAME

(71) Applicant: Nathan Morrow Jackson, Rio Rancho, NM (US)

(72) Inventor: Nathan Morrow Jackson, Rio Rancho, NM (US)

(21) Appl. No.: 19/246,637

(22) Filed: Jun. 23, 2025

Related U.S. Application Data
(60) Provisional application No. 63/663,551, filed on Jun. 24, 2024.

(51) Int. Cl. F26B 3/12; F26B 21/00

(52) U.S. Cl. CPC F26B 3/12; F26B 21/004

(57) ABSTRACT

A variety of applications can include systems and methods related to vibrating mesh atomizers for dry powder generation. A spray-drying system can include a silicon vibrating mesh atomizer structured to receive a liquid and generate aerosol droplets; a heater at an outlet of the silicon vibrating mesh atomizer, where the heater is structured to evaporate liquid components of the aerosol droplets; and a collector to collect solid particles from the evaporation of the aerosol droplets. Variations of the silicon vibrating mesh atomizer or variations of associated heaters can be implemented to provide a controlled distribution of solid particles from an aerosol generated from a selected liquid.

### CLAIM OF PRIORITY

This application claims the priority benefit of U.S. Provisional Application Ser. No. 63/663,551, filed 24 Jun. 2024, entitled “Vibrating Mesh Atomizer for Dry Powder Generation and Method of Making the Same,” which application is incorporated herein by reference in its entirety.

### FIELD OF THE INVENTION

The invention relates generally to vibrating mesh atomizer systems and dry powder generation along with fabrication and use of the same.

### BRIEF DESCRIPTION OF THE DRAWINGS

Embodiments of the invention are illustrated by way of example and not limitation in the figures of the accompanying drawings in which:

FIG. 1A is a representation illustrating a spray-drying process and components of a system for spraying drying, in accordance with various embodiments.

FIG. 1B is an image of a benchtop lab spray-drying machine, in accordance with various embodiments.

FIGS. 2A-2C are schematics of various atomizer technologies and their operation, in accordance with various embodiments.

FIGS. 3A-3C show droplet size distribution graphs of an ultrasonic atomizer, a metallic vibrating mesh atomizer, and a silicon vibrating mesh atomizer, in accordance with various embodiments.

FIGS. 4A-4D show volume frequency versus particle size for a number of liquids, in accordance with various embodiments.

FIGS. 5A-5C show comparisons of metallic vibrating mesh atomizer and silicon vibrating mesh atomizer, in accordance with various embodiments.

FIGS. 6A-6B show preliminary data on powder size comparison of a metallic vibrating mesh atomizer and a silicon vibrating mesh atomizer, in accordance with various embodiments.

FIG. 7 is a schematic of an example design for high viscosity liquids using a silicon vibrating mesh atomizer with heater, in accordance with various embodiments.

FIG. 8 is a schematic of an example silicon vibrating mesh atomizer with heater integration for powder generation and collection, in accordance with various embodiments.

FIG. 9 is representation of an example spray-drying process, in accordance with various embodiments.

FIG. 10A is a representation of a top view of an example vibrating mesh atomizer with various nozzle dimensions on a single membrane within specific microfluidic chamber area, in accordance with various embodiments.

FIG. 10B is a representation of a side view of nozzles of an example vibrating mesh atomizer with integrated microfluidic chamber, corresponding to the vibrating mesh atomizer of FIG. 10A, in accordance with various embodiments.

FIG. 11 is a flow diagram of features of an example method of forming a spray-drying system, in accordance with various embodiments.

FIG. 12 is a flow diagram of features of an example method of operating a spray-drying system, in accordance with various embodiments.

### DETAILED DESCRIPTION

The following detailed description refers to the accompanying drawings that show, by way of illustration and not limitation, various example embodiments of the invention. These embodiments are described in sufficient detail to enable those skilled in the art to practice these and other embodiments. To avoid obscuring embodiments of the invention, some well-known system configurations and process steps are not disclosed in detail. Other embodiments may be utilized, and structural, logical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

An overall goal to develop a novel method to generate dry powders with reduced and uniform particle size distribution can be accomplished by using a silicon-based vibrating mesh atomizer (Si-VMA) to control aerosol droplets to greater than 90% efficiency and by integrating a small-scale heating chamber to dry the aerosol to generate dry powders. Si-VMA can also be referred to as a silicon membrane-based VMA. Aerosol droplets typically consist of approximately 75% liquid and 25% solid particles. Though aerosol droplets can have other ratios of liquid and solid, for the 75/25 configuration, a 10 μm aerosol droplet would produce around a 2.5 μm powder size, depending on shape of the aerosol and agglomeration of the particles.

Dry powders are extensively used in numerous applications, such as pharmaceutical drugs and vaccines, dairy industry, food ingredients, and generation of nanoparticles (ceramic and metals) for additive manufacturing and composites. Micro-scale dry powders are currently produced using a spray-drying technique. The spray-drying industry is a $5.6B industry as of 2022 with a Compound Annual Growth Rate (CAGR) of 6.16% and expected to be a $9B industry by 2030.

Conventional spray-drying techniques, which uses commercial atomizers (pressure or ultrasound), typically have poor aerosol droplet size distribution control, resulting in poor yield efficiency (20-60%) for a specified droplet size. This technique results in dry powders of various sizes from ultrafine particles less than 200 nm to large particles greater than 100 μm within the same batch, which leads to poor bioavailability, inconsistency in inhaled drug delivery, and issues with dissolution in the pharmaceutical industry. If the aerosol has a wide size range, then when the liquid portion is evaporated, the dry particles inside the aerosol will also have varying sizes. It also results in poor yield in other industries, meaning that most of the powders generated are discarded as they need to be further filtered. Large span or size distributions affect powder compaction for tablets, which impacts quality, thus reducing span is critical for improving quality in pharmaceutical industry.

In particle size analysis, span is a measure of the width or spread of a particle size distribution. A smaller span indicates a narrower distribution, where the particles are more uniform in size, while a larger span suggests a wider distribution with more variation in particle sizes. Herein, the span gives a quantitative value for the distribution of droplet sizes. Span is calculated using the formula

SPAN=(X₉₀−X₁₀)/X₅₀.

X₉₀, also referred to as D₉₀ or D90, is the point in the size distribution, up to and including which, 90% of the total volume of material in the given sample is contained. For example, if X₉₀ is 745 nm, then 90% of the given sample has a size of 745 nm or smaller. X₅₀, also referred to as D₅₀ or D50, is the size point below which 50% of the given sample material is contained. X₁₀, also referred to as D₁₀ or D10, is the size below which 10% of the given material is contained. Span, as used herein, gives an indication of how far the 10 percent and 90 percent points are apart, normalized with respect to the midpoint.

Microsystems technology can be used to create a Si-VMA, which was previously developed as a portable nebulizer with enhanced inhaled drug delivery, for dry powder generation. The Si-VMA has unique properties that result in enhanced performance, including narrow droplet size distribution (low span less than 0.5) and the ability to easily modify the device to provide droplet sizes as specified by a user. Si-VMAs can be modified, as taught herein, to include a heater at the outlet of the Si-VMAs to evaporate the liquid components in the aerosol to create a dry powder. The generation of various dry powders can be implemented in pharmaceuticals, diary, and metal/ceramic nanoparticles along with numerous other applications.

In various embodiments, a Si-VMA can be developed with an integrated heating chamber with narrow droplet size distribution. The integrated heating chamber can be monolithically formed at an outlet nozzle of the Si-VMA. The capability of the Si-VMA for generating dry powder on the microscale to nanoscale level can be validated. The Si-VMA can provide characterization of powders (nanoparticles/microparticles) size distribution of various powders from different liquid concentrations. The Si-VMA can provide comparable or better performance to other atomizers including commercial spray-drying systems.

Si-VMA can be used to create dry powders, which the inventor expects will generate powders with narrow particle size distribution that can significantly improve drug delivery and bioavailability as well as increase yield. The system can have similarities to previously developed Si-VMA by the inventor but enhanced by the inclusion of an integrated heater at the outlet nozzle to evaporate the liquid component of the droplets.

Dry powders are used in various applications, but one of the significant problems with existing technologies for preparing dry powders is that the existing technologies produce a wide range of powder sizes that then need further processing to reduce the sizes. This processing can result in low yields of 20% to 50%, for example.

VMA systems, as taught herein, may bypass the extra processing steps of existing technologies, and can easily be modified or adjusted to meet different size demands from sub-micron up to 50 μm particle sizes. This flexibility can significantly impact the pharmaceutical industry, which uses spray-drying to create dry powders for inhalers, ingested drugs (tablets/capsules), and other dry powder applications. The VMA system could also be used to create higher-quality dairy products and food ingredients. It can potentially be used in non-medical applications such as creating ceramic or metal particles for additive manufacturing. Other uses of this technology may include the next generation of electric vehicle (EV) batteries for cars along with additive manufacturing. The technology also has the capability of being small-scale and portable, which can be useful for space exploration or military applications, where only a small amount of powders are needed for food ingredients or individual drug delivery.

Overall, the VMA systems can be used to enhance powder size uniformity, which eventually can be integrated into existing spray-dryers. Atomizers are widely used for spray-drying and the mechanism of evaporating liquid to generate dry powder is well known. Si-VMA systems, as developed by the inventor, have been validated to provide a lower span of droplet size distribution.

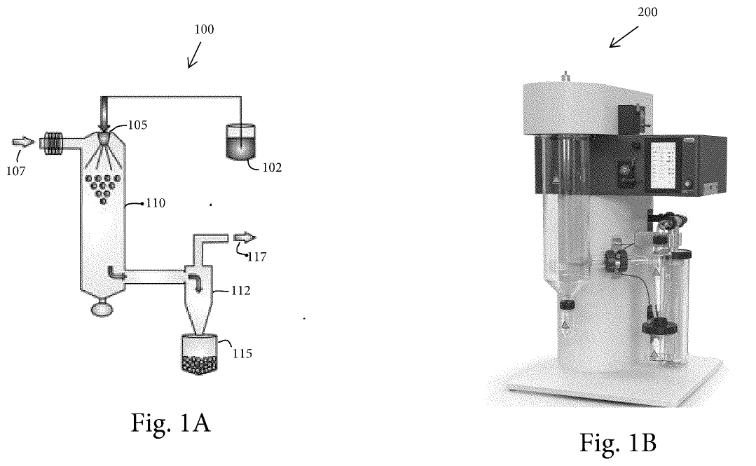

FIG. 1A is a representation illustrating a spray-drying process and components of a spray-drying system 100. Spray-drying is a technique used by numerous industries to make powders from a liquid. Spray-drying system 100 can include a liquid feeder 102, a drying chamber 110 to evaporate the liquid in the aerosol, gas 107 to dry and transport the dry particles to the collector 115, and exhaust gas 117 from the process. There are numerous designs on how to evaporate, transport, and collect the dry powder, which is dependent on the manufacturer of the various spray-drying machines. However, the heart of spray-drying system 100 is an atomizer 105 that creates the aerosol, which are droplets of a suspension of particles. The liquid component of the aerosol is then evaporated in a heating chamber 110 of spray-drying system 100. A cyclone 112 can be used with heating chamber 110 to separate exhaust gas 117 and dry particles to collect the dry particles at collector 115. FIG. 1B is an image of a spray-drying system 200, similar to the representation of FIG. 1A.

Atomizers, at this time, alone are about a $975-billion industry and are used by numerous industries including, but not limited to, nebulizers for inhaled drug delivery, pesticides, humidifiers, cooling systems, additive manufacturing, or other spray devices. However, despite atomizers wide use there are only two major types of atomizers whose technology has not changed since the 1960's, which are air pressure atomizers and ultrasonic atomizers. The air pressure atomizer is the oldest type of atomizer that uses compressed gas to push fluid through a nozzle. Ultrasound atomizers are submerged in liquid and use high frequency ultrasound waves to create cavitation. Since these technologies are mature and well understood, integrating them into systems is relatively easy and low cost, as spray-drying manufacturers buy off-the-shelf atomizers. However, these types of atomizers have a couple of major disadvantages. First, they generate poor droplet size uniformity (large span>2), which means that they generate ultrafine to large droplet sizes (0.2 μm-150 μm) within the same batch. Second, they are typically bulky requiring pumps, nozzles, baffles, tubing, and numerous other components.

Metallic-based VMAs were developed about 15 years ago in an attempt to overcome the issues with uniformity of droplet size or reduced span and were relatively successful in the nebulizer industry reducing the span from approximately two with ultrasonics to approximately one, which meant that about 80% of droplets formed were within 20 μm of the intended 5 μm droplet size.

A Si-VMA, developed by the inventor, offers significant advantages over the commercial metallic VMA. First, Si-VMAs can provide lower span or better uniformity of droplet size to >95% efficiency, which corresponds to a span of <0.5 compared to metallic VMA with span of >1. Second, Si-VMAs can provide the ability to atomize higher viscosity liquids. Metallic VMAs and ultrasound atomizers are limited to low viscosity liquids of <2 cP, while Si-VMAs can handle up to 45 cP liquids to date. Si-VMAs can be implemented using lower power such as <1 W compared to ultrasonics, which require >60 W. Si-VMAs can be less bulky than metallic VMAs, as electronics can be integrated onto the chip of the Si-VMA since it is manufactured using semiconductor technology. Si-VMAs can have lower costs, as it can be batch fabricated.

Si-VMAs, developed by the inventor, have been demonstrated to have use in various applications such as inhaled drug delivery, spin-spray coating for advanced manufacturing of conducting inks, and as an alternative vaping tool. A major advantage of the inventor's Si-VMA over other atomizers is the reduced span, as the inventor's Si-VMA has demonstrated to produce span of <0.5, where >95% of droplets were in the fine particle size, whereas metallic VMAs only had 22% and ultrasonics and air pressure were <10%. The Si-VMA can also easily be adjusted by altering the photomask in fabrication to create any size droplet needed from sub-micron to 50 μm, as the droplet size matches almost exactly to the outlet nozzle dimensions. By changing the etching of the nozzles, one can alter outlet nozzle dimensions to meet user specifications. For example, if a user wants a 5 μm droplet size or 15 μm droplet size, the inventor's Si-VMA can produce atomizers to meet these specifications with 95% efficiency.

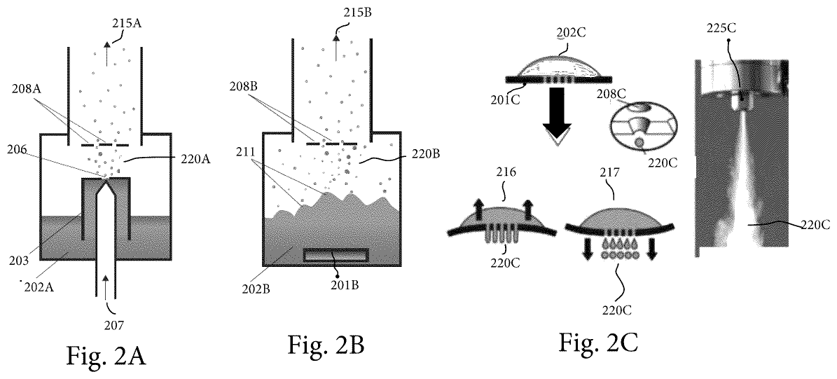

FIGS. 2A-2C are representations of a pressure atomizer, ultrasound technology, a VMA, and their operation. FIG. 2A represents a pressure atomizer 200A in which a pressured air source 207 is provided through a feed tube 203 in a reservoir 202A. Pressured air source 207 provides a jet 206 of aerosol 220A from the end of the narrowed pressured air source. Aerosol 220A is provided through a baffle 208A to provide output 215A. In an example, output 215A can be to a mouthpiece.

FIG. 2B represents an ultrasound atomizer 200B in which operation of a piezoelectric transducer 201B in a reservoir 202B is used. Piezoelectric transducer 201B is used to generate ultrasound waves to create cavitation that generates capillary waves 211 to provide an aerosol 220B. Aerosol 220B is provided through a baffle 208B to provide output 215B. In an example, output 215B can be to a mouthpiece.

FIG. 2C represents a VMA 200C in which operation of a piezoelectric actuator 201C is used with respect to a fluid 202C. A droplet 220C can be provided from hole 208C to the fluid by operation of piezoelectric actuator 201C. Piezoelectric actuator 201C can be used to provide a push 216 that generates droplets 220C and a pull 217 that generates droplets 220C. An aerosol 220C can be provided from a nozzle 225C coupled as a final output to the output holes 208C of piezoelectric actuator 201C encased as a portal device. In an example, nozzle 225C can be part of a mouthpiece.

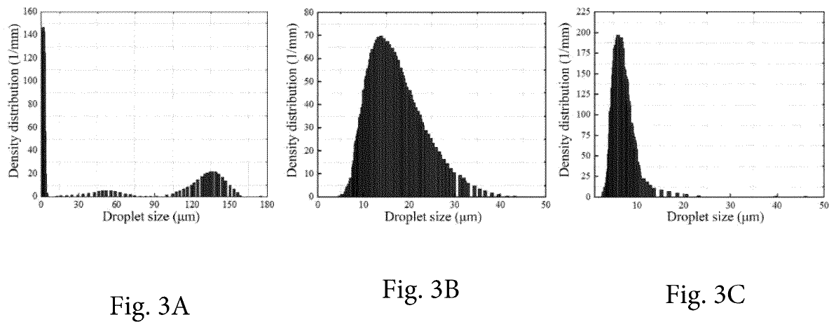

FIGS. 3A-3C show droplet size distribution graphs of an ultrasonic atomizer, a metallic VMA, and a Si-VMA. FIG. 3A is a plot of density distribution versus droplet size for an ultrasonic device indicating a relatively wide range of droplet sizes. FIG. 3B is a plot of density distribution versus droplet size for a metallic VMA indicating a narrower range of droplet sizes than the ultrasonic device of FIG. 3A. FIG. 3C is a plot of density distribution versus droplet size for a Si-VMA indicating a narrower range of droplet sizes than the metallic VMA of FIG. 3B. In addition, the Si-VMA associated with FIG. 3C can have a narrower range having a smaller droplet size as the center of the distribution than the metallic VMA associated with FIG. 3B.

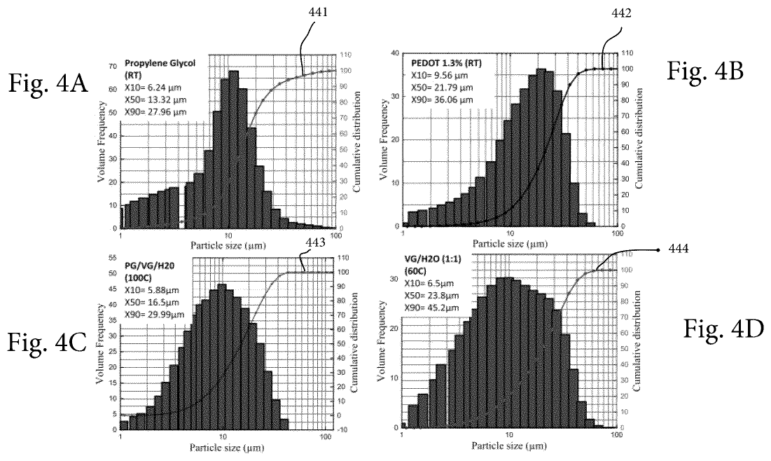

FIGS. 4A-AD show volume frequency versus particle size for a number of materials using a Si-VMA. FIG. 4A shows a plot of volume frequency versus particle size for propylene glycol at room temperature (RT) along with curve 441 of a cumulative distribution versus particle size. FIG. 4B shows a plot of volume frequency versus particle size for 1.3% poly (3,4-ethylenedioxythiophene) (PEDOT) at RT along with curve 442 of a cumulative distribution versus particle size. FIG. 4C shows a plot of volume frequency versus particle size for propylene glycol (PG)/vegetable glycerin (VG)/H₂O at 100° C. along with curve 443 of a cumulative distribution versus particle size. FIG. 4D shows a plot of volume frequency versus particle size for VG/H₂O at a 1:1 ration at 60° C. along with curve 444 of a cumulative distribution versus particle size. The results are relatively consistent.

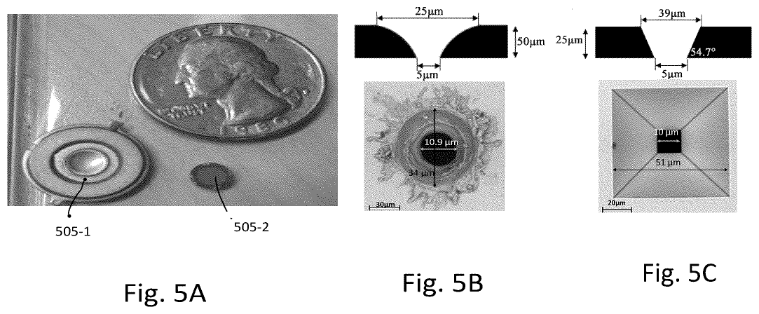

FIGS. 5A-5C show comparisons of a metallic VMA and a Si-VMA. FIG. 5A compares the sizes of metallic VMA 505-1 and Si-VMA 505-2 with respect to each other and with respect to a quarter. FIG. 5B shows a side view and a top view of a metallic VMA having an output opening of 5 μm from an input having an opening of 25 μm. FIG. 5C shows a side view and a top view of a Si-VMA having an output opening of 5 μm from input having an opening of 39 μm. FIG. 5C also indicates that a Si-VMA of similar size to a metallic VMA can have a smoother, more uniform structure.

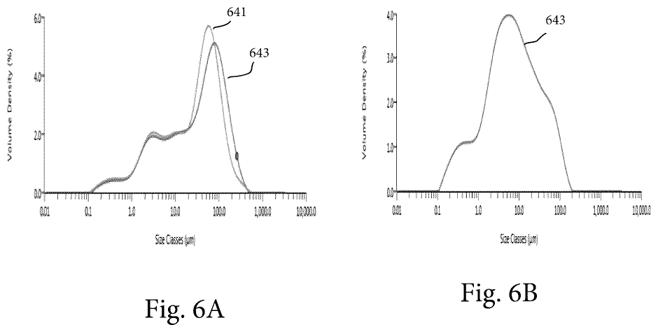

FIGS. 6A-6B show preliminary data on powder size comparison of a metallic VMA and a Si-VMA. FIG. 6A shows curves 641 and 643 as a plot of volume density versus size classed for a metallic VMA with a 5 μm nozzle providing a D50 value of 59 μm. FIG. 6B shows a curve 642 as a plot of volume density versus size classes for a Si-VMA with a 5 μm nozzle providing a D50 value of 16.5 μm.

In spray-drying systems, the atomizers control how the aerosols are generated and the properties associated with them. As illustrated above, current spray-dryers that use either air pressure or ultrasonic atomizers as the generation mechanisms result in a wide range of droplet sizes. If the droplet sizes vary in range, then the particles within the droplets can also vary in size when the liquid is evaporated. This has been validated by numerous studies illustrating the large span of powder sizes collected by conventional spray-drying methods. Span ranges can be on the order of 1.5 to greater than 3 with D10, D50 and D90 sizes of 19, 106, and 231 μm for asthma drugs. This has been shown to be the case in various applications from pharmaceutical drug powders, dairy (dry milk), and metal or ceramic particles for additive manufacturing. Producing large range of powder sizes results in significantly low yield (20-50%) and other key issues leading to lower quality products depending on the liquid drug formulation.

Si-VMAs can produce more uniform droplet sizes than the conventional mechanisms, which should result in dry powders generated from the droplets also being uniform, as the particles cannot be bigger than the droplets. Thus, when the liquid is evaporated, the dry powders formed should be of similar size or less, therefore decreasing the span and increasing yield. Preliminary work is shown in FIGS. 6A and 6B. When compared to metallic VMA atomizer by atomizing sugar solution, though the Si-VMA showed better uniformity in dry powder size compared to metallic VMA, the range was quite large. It is believed that the range was due to how the powders were evaporated (hot plate) and collected which lead to clustering (aggregation) of the powders.

In various embodiments, a heating chamber connected to the Si-VMA can significantly improve range results, as controlling evaporation and collection of powders should reduce size range. With the Si-VMA only producing droplets on the order of 5-10 μm, then particles within the droplets need to be smaller than the droplets, which leads to a best explanation for larger powder sizes being formed due to aggregation which can be avoided through controlling evaporation and proper collecting of the powders.

In various embodiments, the design and fabrication of a Si-VMA with varying nozzle dimensions from, but not limited to, 1 μm to 50 μm can be implemented to impact droplet size on powder size. Different size nozzles within a single device can create a wide span of aerosol droplets and dry particles, or one section of nozzles can be used at a time to obtain precise droplet/particle size. Controlling nozzle dimensions can not only affect droplet size but droplet shape, where the droplet shape impacts the dried particle shape. By using various nozzle dimensions, the morphology of the dry particles collected can be altered or controlled.

A heating chamber can be designed to attach to the Si-VMA to evaporate the liquid as it leaves the outlet nozzle. The heater can be monolithically integrated as part of the Si-VMA. Herein, monolithic integration is a process of fabricating multiple electronic components, within or as grown from a single piece of semiconductor material, such as but not limited to silicon. The heater can be monolithically integrated using semiconductor fabrication techniques to the outlet of the atomizer. In another embodiment, a Si-VMA can be positioned resting on a heating chamber with integrated heating pads to evaporate the liquid.

In addition to heating the Si-VMA at the outlet of the Si-VMA, a spray-dry system can be structured to heat the collecting tray to further evaporate the aerosol upon impact. Use of heaters with a Si-VMA in a spray-dry system benefits from the properties of Si-VMA that provide the Si-VMA the ability to handle high temperature, whereas metallic VMAs cannot handle such high temperatures.

Si-VMAs, as taught herein, can be structured with enhanced features. The nozzle structure of the Si-VMA can be designed to provide higher outlet droplet velocity than metallic VMAs, which leads to faster evaporation rate. In addition, such Si-VMAs can handle higher viscosity liquids up to 45 cP and with an integrated top heater to reduce viscosity of liquids, viscous liquids up to 200 cP can be atomized. The capability to handle higher viscosity liquids allows the use of Si-VMAs for spray-drying of metal particles that are used in composites, additive manufacturing, and pharmaceuticals. Most current atomizers can only work with aqueous solutions that are water based solutions with a viscosity less than 3 cP, which may be adequate for pharmaceuticals but cannot be used with dairy particles or metal particles.

Characterization of droplet and powder size associated with a Si-VMA spray-dry system can be performed to form a correlation between these parameters. The correlation can be used when designing a Si-VMA spray-dry system for specific liquids to be used in different applications.

For spray-drying, atomizers can be created with various outlet dimensions including, but not limited to, a set of 1, 5, 10, 25, and 50 μm. The use of various outlet dimensions allows applications to target different size particles. The outlet nozzles can be constructed using various etching procedures. FIG. 5C illustrates an etching taper of 54.74° due to crystal plane geometry of silicon. For other structures to have the same thickness, the parameters of an outlet nozzle can be calculated using geometry associated with FIG. 5C. The photomask dimensions for processing can be varied accordingly, which can be performed using a maskless aligner. The manufacturing process can include using silicon-on-insulator wafers with thermally grown oxide. The oxide can be patterned to act as a mask layer. An etchant, such as a KOH etchant, can be used to etch the silicon with the 54.74° taper or other selected taper, down to the buried oxide layer. Then, deep reactive ion etching (DRIE) or wet etching can be used to remove the handle wafer. For an example design, atomizers can be assembled using a piezoelectric ring and a holder along with a 3D printed reservoir to hold the liquid. Other structural formats can be implemented.

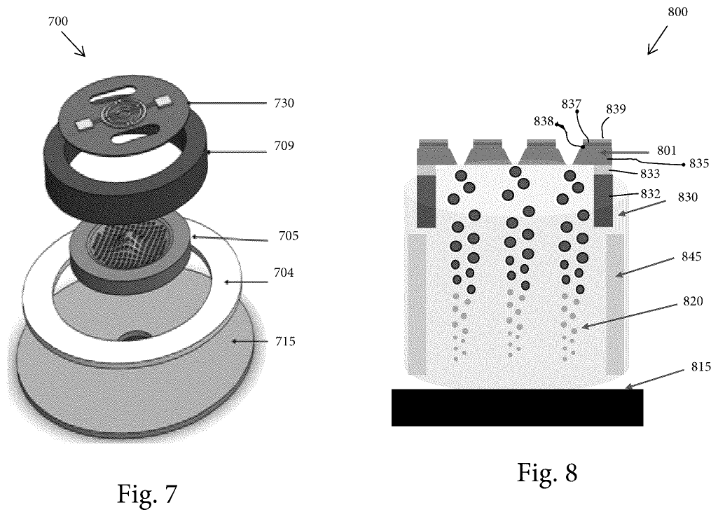

FIG. 7 is a schematic of an embodiment of an example design of a Si-VMA spray-dry system 700 that is suitable for high viscosity liquids using a Si-VMA having a heater. VMA spray-dry system 700 can include a Si-VMA 705 with a piezoelectric actuator ring 704 such as, but not limited to, a lead zirconate titanate (PZT) ring, above a holder 715. A microheater 730 can be structured above Si-VMA 705 to reduce viscosity of liquids being processed. Microheater 730 can be located directly on Si-VMA 705 or separated from Si-VMA 705 by a spacer 709. Microheater 730 can be monolithically integrated with Si-VMA 705 in formation of Si-VMA 705. Though not shown in FIG. 7, one or more heaters can be monolithically integrated with Si-VMA 705 at outlets of Si-VMA 705.

FIG. 8 is a schematic of an embodiment of an example Si-VMA spray-dry system 800 having a Si-VMA 801 with a heater integration for powder generation and collection. Si-VMA 801 can include a silicon vibrating mesh membrane 835 with a first electrode 838 on silicon vibrating mesh membrane 835, where first electrode 838 is separated from a second electrode 839 by a piezoelectric film 837. Piezoelectric film 837 can be sandwiched between and contacting first electrode 838 and second electrode 839. Piezoelectric film 837 can be, but is not limited to, a PZT film. Silicon vibrating mesh membrane 835 is disposed above a silicon-based substrate 832, separated from substrate 832 by an electrically insulating region 833. A heater can be integrated in silicon-based substrate 832.

A small-scale heating chamber can be bonded to the holder of Si-VMA 801 at the outlet for the aerosol from Si-VMA 801. The heating chamber can be a glass cylinder with integrated flexible heaters 845. Flexible heaters 845 can include, but are not limited to, silicone heaters that can produce temperatures of greater than 200° C. The heaters can be connected to a temperature controller to alter the heat and to determine an optimal temperature to evaporate the liquids. The heaters can be placed on the outside of the glass cylinder, and one can use finite element modelling to determine heat distribution during the design to estimate the average temperature at the center of the cylinder. The cylinder shape can be based on average cone angle of Si-VMA 801. Si-VMA spray-dry system 800 can also include a collector tray 815 to collect evaporated particles 820. Collector tray 815 can be 3D printed and coated with antistatic material to reduce agglomeration or clustering of powders.

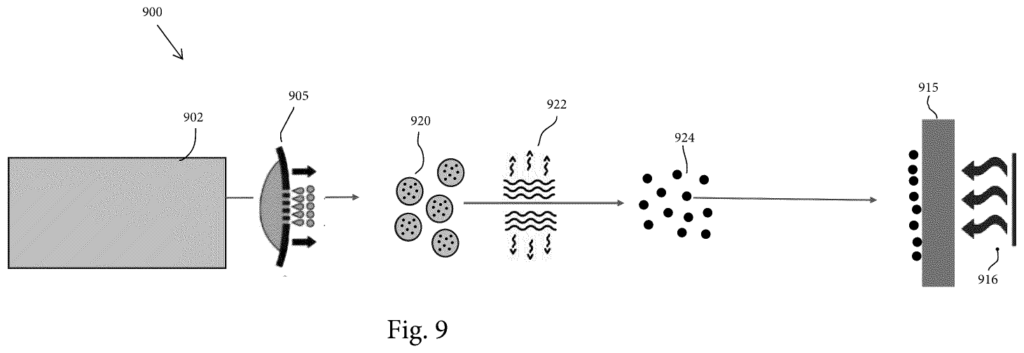

FIG. 9 is representation of an embodiment of an example spray-drying process 900. The evaporation process flows from left to right in FIG. 9, starting with a bulk liquid solution 902. A Si-VMA 905 provides atomization, forming aerosol droplets 920, which have liquid and solid particles. Aerosol droplets 920 undergo evaporation 922 of liquid components. Via evaporation, the liquid part of aerosol droplets 920 is removed and what remains are just the solid particles 924 that are left through heating at the outlet of Si-VMA 905. Solid particles 924 are transported to a collecting tray 915 through air, a gas such as but not limited to nitrogen gas, or a vacuum. Collecting tray 915 can be heated via a heating source 916 to remove any potential residue liquid on solid particles 924. Though not shown, a heating element can be used to subject liquid from bulk liquid solution 902 to higher temperatures prior to atomization. Spray-drying process 900 can include permutations of a heating prior to an atomization operation by Si-VMA 905, heating at the outlet of Si-VMA 905, and heating at collecting tray 915.

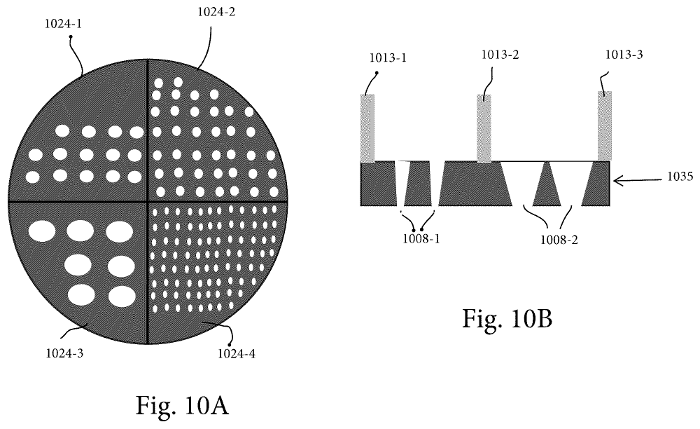

FIGS. 10A-10B are representations of a Si-VMA with various nozzle dimensions within a single Si-VMA device. FIG. 10A is a representation of a top view of the Si-VMA having four sections 1024-1, 1024-2, 1024-3, and 1024-4 in which the nozzle dimensions of a given section are different from the nozzle dimensions of the other sections. Each section can be associated with a nozzle dimension for a specific microfluidic chamber area. This allows for atomization of a liquid with a specific droplet size, which can be varied by putting liquid in different quadrants. For applications having one specific droplet size, one of the microfluidic chambers can be filled with the other microfluidic chambers closed or left unfilled. Though four sections are shown in FIG. 10A, the Si-VMA can be implemented with more or fewer than four sections for different nozzle dimensions.

FIG. 10B is a representation of a side view of nozzles corresponding to the Si-VMA of FIG. 10A. FIG. 10B shows a membrane side view with varying nozzle dimensions within a single Si-VMA device. FIG. 10B shows two of the four microfluidic chambers defining the four sections 1024-1, 1024-2, 1024-3, and 1024-4 of FIG. 10A. The two chambers are defined by chamber walls 1013-1 and 1013-2 and chamber walls 1013-2 and 1013-3 integrated on silicon mesh membrane 1035 with nozzle outlets 1008-1 and 1008-2.

In various embodiments, a spray-drying system can include a Si-VMA, a heater, and a collector. The Si-VMA can be structured to receive a liquid and generate aerosol droplets. The heater can be structured at an outlet of the Si-VMA, where the heater is configured to evaporate liquid components of the aerosol droplets. The collector can be structured to collect solid particles from the evaporation of the aerosol droplets.

Variations of such a spray-drying system or a similar spray-drying system can include a number of different embodiments that may be combined depending on the application of such a spray-drying system and/or the architecture of systems in which such a spray-drying system are implemented. Such a spray-drying system can include the heater being monolithically integrated at the outlet of the Si-VMA. The heater can be integrated in a substrate of the Si-VMA.

Variations of such a spray-drying system or similar spray-drying system can include the Si-VMA having different size nozzles within the Si-VMA. The different size nozzles can be structured in multiple sections of the Si-VMA. The multiple sections can be a partitioning of a silicon mesh membrane of the Si-VMA. Variations can include nozzles in a given section having a common nozzle size. The multiple sections can be defined by multiple microfluidic chambers above a silicon mesh membrane of the Si-VMA.

Variations of such a spray-drying system or similar spray-drying system can include the heater being flexible and being attached to a heating chamber bonded to a holder of the Si-VMA. Variations can include the spray-drying system having the heater monolithically integrated at the outlet of the Si-VMA, a heating chamber bonded to a holder of the Si-VMA, and a flexible heater attached to the heating chamber. Variations can include the spray-drying system having a top microheater integrated on top of the Si-VMA, positioned opposite the outlet of the Si-VMA.

Variations of such a spray-drying system or similar spray-drying system can include a top microheater integrated on top of the Si-VMA, opposite the outlet of the silicon vibrating mesh atomizer. The top microheater and the silicon vibrating mesh atomizer can be configured to provide a capability to atomize liquids having a viscosity up to 200 cP. An additional variation of the spray-drying system can include a collector heater to heat the collector. Other variations can include features of spray-drying systems disclosed herein.

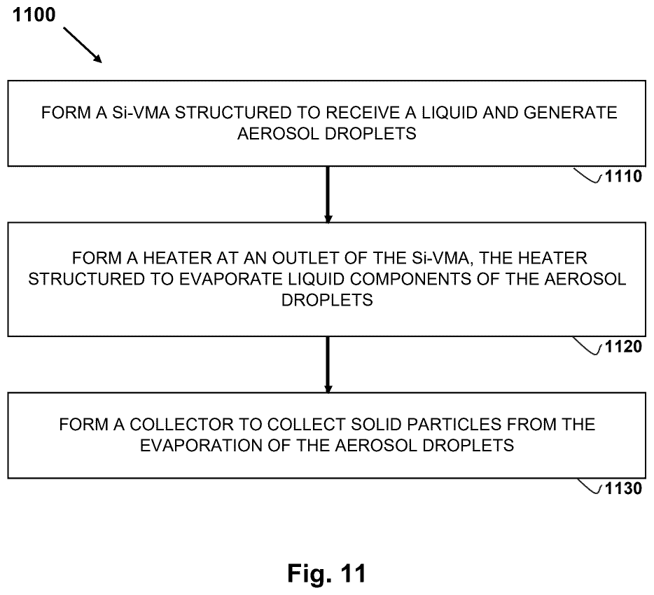

FIG. 11 is a flow diagram of features of an embodiment of an example method 1100 of forming a spray-drying system. At 1110, a Si-VMA is structured to receive a liquid and generate aerosol droplets. At 1120, a heater is formed at an outlet of the Si-VMA, where the heater is structured to evaporate liquid components of the aerosol droplets. At 1130, a collector is formed to collect solid particles from the evaporation of the aerosol droplets.

Variations of method 1100 or methods similar to method 1100 can include a number of different embodiments that may be combined depending on the application of such methods and/or the architecture of systems in which such methods are implemented. Such methods can include forming the heater by monolithically integrating the heater at the outlet of the silicon vibrating mesh atomizer.

Variations of method 1100 or methods similar to method 1100 can include forming nozzles of different dimensions in a silicon mesh membrane for the silicon vibrating mesh atomizer; and forming multiple microfluidic chambers on the silicon mesh membrane such that the silicon mesh membrane is arranged as multiple sections with each section having nozzles of a common nozzle dimension that is different from nozzle dimensions of other sections of the multiple sections.

Variations of method 1100 or methods similar to method 1100 can include, in addition to forming the heater at the outlet of the silicon vibrating mesh atomizer, forming one or more of a top microheater integrated on top of the silicon vibrating mesh atomizer, opposite the outlet of the silicon vibrating mesh atomizer; a flexible heater attached to a heating chamber bonded to a holder of the silicon vibrating mesh atomizer; or a collector heater coupled to the collector. Variations can include forming other features of a Si-VMA disclosed herein or permutations of features of Si-VMAs disclosed herein.

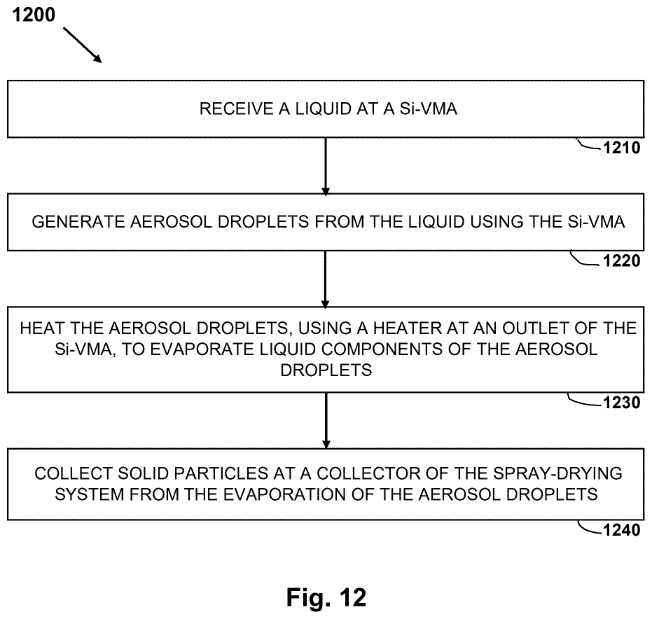

FIG. 12 is a flow diagram of features of an embodiment of an example method 1200 of operating a spray-drying system. At 1210, a liquid is received at a Si-VMA. At 1220, aerosol droplets are generated from the liquid using the Si-VMA. At 1230, the aerosol droplets are heated using a heater at an outlet of the Si-VMA to evaporate liquid components of the aerosol droplets. At 1240, solid particles are collected at a collector of the spray-drying system from the evaporation of the aerosol droplets.

Variations of method 1200 or methods similar to method 1200 can include a number of different embodiments that may be combined depending on the application of such methods and/or the architecture of systems in which such methods are implemented. Such methods can include generating solid particles with selected sizes, using the Si-VMA partitioned into sections of nozzles having varied sizes.

Variations of method 1200 or methods similar to method 1200 can include atomizing liquids having a viscosity in a range of 45 cP to 200 cP. Variations can include controlling morphology of the solid particles collected at the collector, using nozzles of the silicon vibrating mesh atomizer of various nozzle dimensions. Variations can include operating other features of operation of a Si-VMA disclosed herein or permutations of features of operating Si-VMAs disclosed herein.

Although specific embodiments have been illustrated and described herein, it will be appreciated by those of ordinary skill in the art that any arrangement that is calculated to achieve the same purpose may be substituted for the specific embodiments shown. Upon studying the disclosure, it will be apparent to those skilled in the art that various modifications and variations can be made in the devices and methods of various embodiments of the invention. Various embodiments can use permutations and/or combinations of embodiments described herein. It is to be understood that the above description is intended to be illustrative, and not restrictive, and that the phraseology or terminology employed herein is for the purpose of description.

What is claimed is:

1. A spray-drying system comprising:
a silicon vibrating mesh atomizer structured to receive a liquid and generate aerosol droplets;
a heater at an outlet of the silicon vibrating mesh atomizer, the heater structured to evaporate liquid components of the aerosol droplets; and
a collector to collect solid particles from the evaporation of the aerosol droplets.

2. The spray-drying system of claim 1, wherein the heater is monolithically integrated at the outlet of the silicon vibrating mesh atomizer.

3. The spray-drying system of claim 1, wherein the silicon vibrating mesh atomizer has different size nozzles within the silicon vibrating mesh atomizer.

4. The spray-drying system of claim 3, wherein the different size nozzles are structured in multiple sections of the silicon vibrating mesh atomizer.

5. The spray-drying system of claim 4, wherein the nozzles in a given section have a common nozzle size.

6. The spray-drying system of claim 4, wherein the multiple sections are defined by multiple microfluidic chambers above a silicon mesh membrane of the silicon vibrating mesh atomizer.

7. The spray-drying system of claim 1, wherein the heater is flexible and is attached to a heating chamber bonded to a holder of the silicon vibrating mesh atomizer.

8. The spray-drying system of claim 1, wherein the spray-drying system includes:
the heater being monolithically integrated at the outlet of the silicon vibrating mesh atomizer;
a heating chamber bonded to a holder of the silicon vibrating mesh atomizer; and
a flexible heater attached to the heating chamber.

9. The spray-drying system of claim 8, wherein the spray-drying system includes a top microheater integrated on top of the silicon vibrating mesh atomizer, opposite the outlet of the silicon vibrating mesh atomizer.

10. The spray-drying system of claim 1, wherein the spray-drying system includes a top microheater integrated on top of the silicon vibrating mesh atomizer, opposite the outlet of the silicon vibrating mesh atomizer.

11. The spray-drying system of claim 10, wherein the top microheater and the silicon vibrating mesh atomizer are configured to provide a capability to atomize liquids having a viscosity up to 200 cP.

12. The spray-drying system of claim 1, wherein the spray-drying system includes a collector heater to heat the collector.

13. A method of forming a spray-drying system, the method comprising:
forming a silicon vibrating mesh atomizer structured to receive a liquid and generate aerosol droplets;
forming a heater at an outlet of the silicon vibrating mesh atomizer, the heater structured to evaporate liquid components of the aerosol droplets; and
forming a collector to collect solid particles from the evaporation of the aerosol droplets.

14. The method of claim 13, wherein forming the heater includes monolithically integrating the heater at the outlet of the silicon vibrating mesh atomizer.

15. The method of claim 13, wherein the method includes:
forming nozzles of different dimensions in a silicon mesh membrane for the silicon vibrating mesh atomizer; and
forming multiple microfluidic chambers on the silicon mesh membrane such that the silicon mesh membrane is arranged as multiple sections with each section having nozzles of a common nozzle dimension that is different from nozzle dimensions of other sections of the multiple sections.

16. The method of claim 13, wherein the method includes, in addition to forming the heater at the outlet of the silicon vibrating mesh atomizer:
forming one or more of a top microheater integrated on top of the silicon vibrating mesh atomizer, opposite the outlet of the silicon vibrating mesh atomizer;
forming a flexible heater attached to a heating chamber bonded to a holder of the silicon vibrating mesh atomizer; or
forming a collector heater coupled to the collector.

17. A method of operating a spray-drying system, the method comprising:
receiving a liquid at a silicon vibrating mesh atomizer;
generate aerosol droplets from the liquid using the silicon vibrations mesh atomizer;
heating the aerosol droplets, using a heater at an outlet of the silicon vibrating mesh atomizer, to evaporate liquid components of the aerosol droplets; and
collecting solid particles at a collector of the spray-drying system from the evaporation of the aerosol droplets.

18. The method of claim 17, wherein the method includes generating solid particles with selected sizes, using the silicon vibrating mesh atomizer partitioned into sections of nozzles having varied sizes.

19. The method of claim 17, wherein the method includes atomizing liquids having a viscosity in a range of 45 cP to 200 cP.

20. The method of claim 17, wherein the method includes controlling morphology of the solid particles collected at the collector, using nozzles of the silicon vibrating mesh atomizer of various nozzle dimensions.
